(19) United States
(12) Patent Application Publication
(10) Pub. No.: US 2006/0098554 A1
(43) Pub. Date: May 11, 2006

(54) Chromatic aberration-correcting optical system and optical pickup device using the same

(75) Inventors: Tetsuo Ariyoshi, Osaka-shi (JP); Ho Seop Jeong, Kyunggi-Do (KR); Soo Jin Jung, Kyunggi-Do (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 11/043,504

(22) Filed: Jan. 25, 2005

(30) Foreign Application Priority Data
Nov. 5, 2004 (KR) 2004-89835

(51) Int. Cl. G11B 7/00

(52) U.S. Cl. 369/112.05; 369/112.01

(57) ABSTRACT

Provided is a chromatic aberration-correcting optical system which corrects chromatic aberrations in light beams for a high-density recording medium using a large numerical aperture in addition to allowing the universal adoption of light beams for high- and low-density recording media.

### BACKGROUND OF THE INVENTION

1. Field of the Invention

The present invention relates to the accommodation of various optical recording media of different thicknesses by an optical pickup device. More particularly, the present invention relates to a chromatic aberration-correcting element which allows an optical pickup device to universally adopt optical discs differing in thickness and in recording/reproducing laser wavelength in the presence of only a single objective lens optimally adapted for blue lasers, and an optical pickup device provided with the same.

2. Description of the Related Art

As means for storing image and/or voice information or as a secondary memory unit for computers, optical recording media (hereinafter referred to as just “optical media”), which are now predominant over other recording media, are largely classified into compact discs (CD) with a storage capacity of 650 MB and digital versatile discs (DVD) with a storage capacity of 4.7 GB. Determining the size of information to be recorded or regenerated, the recording density of optical media depends on the optical spot on which a laser can be focused through an objective lens. A focused laser beam has a focal spot diameter scaling S according to the following Equation 1:
S∝λ/NA Equation 1

where λ is the wavelength of the laser beam and NA is the objective lens numerical aperture.

Hence, an increase in recording density is mainly enabled by reducing the spot size by using shorter wavelength light and by increasing the numerical aperture of the objective lens. Nowadays, a blue-violet laser beam is used as a short wavelength light source with an NA over 0.6. For example, as much as 22 GB can be stored by using a blue wavelength (405 nm) in combination with an NA=0.85 objective lens.

However, the high numerical aperture places a stringent constraint on disc tilt because tilt causes coma aberration, which is represented by the following equation.

$${W}_{31} = - \frac{d}{2} \frac{{n}^{2} ( {n}^{2} - 1 ) sin θ cos θ}{{( {n}^{2} - {sin}^{2} θ )}^{5 / 2}} {NA}^{3} \qquad Equation 2$$

where W₃₁ is a coma aberration, θ is a tilt angle of an optical disc, n is a refractive index of the optical disc, d is a thickness of the optical disc, and NA represents a numerical aperture of the optical disc.

Usually, the thickness of an optical disc refers to that from a light incident layer to a recording layer in the optical disc. The refractive index also refers to that measured in the above thickness range. In general, because the signal degradation due to disc tilt is in inverse proportion to the wavelength of the incident laser beam and in direct proportion to the cube of NA of the objective lens, the tolerance for disc tilt sharply decreases with an increase in storage density. In order to compensate for this, an optical disc with a high recording density is reduced in thickness. This is corroborated through Equation 2 in that, to secure a tolerance for disc tilt, disc thickness must be reduced as the numerical aperture of the objective lens is increased for high storage density. For instance, CDs which use a 780 nm beam are 1.2 mm thick, and DVDs are reduced to a thickness of 0.6 mm due to the use of a 650 nm beam. Thus, an optical disc using a blue laser, hereinafter referred to as a ‘blue-ray disc’, or ‘BD’ in abbreviation, is anticipated to be 0.1 mm thick. Of course, the numerical aperture of the objective lens is 0.45 for CDs and 0.6 for DVDs. In the case of BDs, the numerical aperture may be increased to as high as 0.85. As such, an important problem anticipated to stem from the development of new standards of optical discs is found in the compatibility between the new standards and pre-existing ones.

The use of blue wavelength laser beams for recording data at high density requires a high numerical aperture, but causes a problem in that high numerical apertures amplify the influence of aberrations. Particularly the influence of wavelength fluctuation of a semiconductor laser is aggravated. The wavelength fluctuation of a semiconductor laser occurs in response to a change in the temperature of the operational environment or in the beam energy of the semiconductor laser. For instance, when the environment for the emission of a beam from a semiconductor laser changes by one degree Celsius from 25° C., the wavelength fluctuates within a range of ±0.07 nm. A change of 1 mW in the emission energy of a semiconductor laser results in a wavelength fluctuation within a range of ±0.04 nm. In an optical pickup device capable of recording and reproducing data, a semiconductor laser operates with a pulse output of 30 to 50 mW upon recording, which leads to a momentary wavelength fluctuation in the range of 1.2 to 2 nm. A momentary wavelength fluctuation of as large as 2 nm causes a focal point to deviate a distance of as long as 0.35 um when an objective lens with a numerical aperture of 0.85 is used. The positional deviation of the focus is causative of a change in the total focal length of the objective lens because the refractive index of the material of the objective lens changes with the wavelength. The depth of focus of an objective lens is represented by λ/(NA)². When the positional deviation of the focus is as large as or larger than ±λ/(2NA²), optical spots small enough to reproduce data cannot be formed. Where λ=410 nm and NA=0.85, if the positional deviation of focus is as large as λ/(2NA²)=0.28 um, it is almost impossible to record or reproduce data.

Thus, in order to remove the chromatic aberration caused by the use of a short wavelength such as a blue laser, an optical element for correcting chromatic aberrations is positioned in the optical path of the laser. Japanese Pat. Laid-Open Publication No. 2001-256672 discloses a chromatic aberration-correcting element which is provided in the path through which a laser beam propagates. The chromatic aberration-correcting element, consisting of a diffraction optical element and a concave lens, is provided between an objective lens and a semiconductor laser so as to correct chromatic aberration in a short wavelength such as a blue laser.

However, the chromatic aberration-correcting element is not an element that allows DVDs and CDs to be compatibly adopted. Because, after being incident on the chromatic aberration-correcting element, DVD/CD laser beams are diverged or converged, the position where the chromatic aberration-correcting element can be inserted remains limited. For this reason, an optical pickup device provided with the chromatic aberration-correcting element cannot integrate a BD optical system and a DVD/CD optical system therein, but has a complicated structure.

Therefore, there is a need for a chromatic aberration-correcting element that compatibly use light sources of different wavelengths so as to integrate a BD optical system and a DVD/CD optical system therein, in addition to being simple in structure.

### SUMMARY OF THE INVENTION

Accordingly, the present invention has been made keeping in mind the above problems occurring in the prior art, and an object of the present invention is to provide a chromatic aberration-correcting optical system which can universally use BD, DVD and CD light beams.

Another object of the present invention is to provide an optical pickup device which can position BD light and DVD/CD light in the same path by use of the chromatic aberration-correcting element so that it can be simple in structure.

In accordance with an aspect of the present invention, there is provided a chromatic aberration-correcting optical system for use in an optical pickup device, comprising: at least one concave plane for changing light beams for a high-density recording medium and for ant least one low-density recording medium into divergent or convergent light beams; and a diffractive structure, formed on at least one side, for changing divergent or convergent light beams into parallel light beams, the diffractive structure being formed on at least one side of the chromatic aberration-correcting optical system in a concentric pattern which has a step depth and a saw-toothed form so as to confer a maximal diffraction efficiency to second-order diffraction light beams for the high-density recording medium and to first-order diffraction light beams for the low-density recording medium, whereby the chromatic aberration-correcting optical system can correct chromatic aberrations in light beams for the high-density medium and allows the light beams for the high-density recording medium and for the low-density recording medium to be universally used in the optical pickup device.

In accordance with another aspect of the present invention, there is provided a chromatic aberration-correcting optical system for use in an optical pickup device, comprising a concave lens and a convex lens in combination, said convex lens having a diffractive structure on at lest one side.

In accordance with a further aspect of the present invention, there is provided an optical pickup device, comprising: the chromatic aberration-correcting optical system; and a common photodetector for detecting light beams reflected from the high-density recording medium and the low-density recording medium, said light beams reflected from the high-density recording medium taking the path of incident light beams due to the operation of the chromatic aberration-correcting optical system

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are schematic views showing a chromatic aberration-correcting optical system according to an embodiment of the present invention;

FIG. 2 is a schematic view showing a chromatic aberration-correcting optical system according to another embodiment of the present invention;

FIG. 3 shows the paths of light beams passing through the chromatic aberration-correcting optical system;

FIG. 4 shows the chromatic aberration-correcting optical system in partially enlarged views;

FIGS. 5A-5C show plots of diffraction efficiencies versus step depth with regard to BD, DVD and CD wavelengths;

FIGS. 6A-6C show paths that light beams take in an optical pickup device capable of universally adopting BDs, DVDs and CDs;

FIG. 7 is a view showing a structure of an optical pickup device employing the chromatic aberration-correcting optical system of the present invention.

### DESCRIPTION OF THE PREFERRED EMBODIMENTS

Reference now should be made to the drawings, in which the same reference numerals are used throughout the different drawings to designate the same or similar components.

The chromatic aberration-correcting optical system according to the present invention corrects not only chromatic aberrations in short wavelengths for high-density recording media, but also compatibly uses wavelengths for low-density recording media, together with the short wavelengths for high-density recording media.

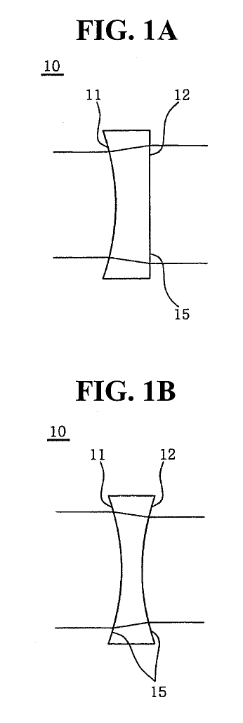

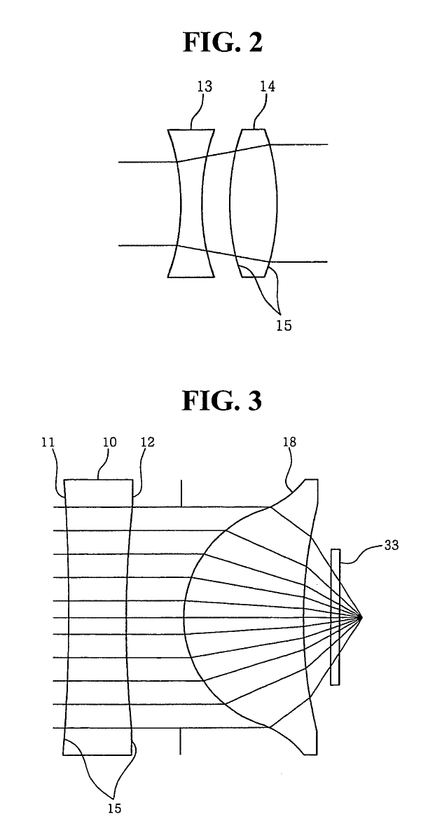

With reference to FIGS. 1A, 1B, and 2, a chromatic aberration-correcting optical system according to the present invention is shown. As seen in the figures, the chromatic aberration-correcting optical system of the present invention comprises at least one concave plane 11 or 12 for changing parallel beams into divergent or convergent light beams and at least one diffractive plane 15 for changing divergent or convergent light beams into parallel light beams, or a concave lens 13 in combination with a convex lens 14 with a diffractive plane 15 formed on at least one side.

In FIG. 1A, a chromatic aberration-correcting optical system comprising one concave plane 11 and one diffractive structure 15 formed on the opposite planar plane is shown in accordance with an embodiment. FIG. 1B shows a chromatic aberration-correcting optical system which comprises two concave planes 11 and 12, each having a diffractive structure 15, in accordance with another embodiment of the present invention. FIG. 2 shows a chromatic aberration-correcting optical system comprising a combination of a concave lens 13 and a convex lens 14 with a diffractive structure 15 formed on each side, in accordance with a further embodiment of the present invention.

The low-density recording medium noted above are described separately as a first and a second low-density optical recording medium: the first is of high density relative to the second. In an embodiment, the high-density recording medium is exemplified by a BD for which a laser beam with a wavelength as short as 405 nm is used in combination with a numerical aperture of 0.85. The first low-density recording medium is a DVD which employs a 650 nm laser beam in combination with a numerical aperture of 0.6 whereas the second low-density recording medium is a CD, employing a 780 nm laser beam in combination with a numerical aperture of 0.4.

The present invention will be described in detail with reference to the chromatic aberration-correcting element having two aspheric concave planes provided with a diffractive structure on each side, shown in FIG. 1B. The diffractive structure 15 is optimally adapted so as to have a maximal diffraction efficiency for BD wavelengths and to correct the chromatic aberration of an objective lens for BDs. If DVD/CD wavelengths different from BD wavelengths are incident on a conventional chromatic aberration-correcting element, the diffraction direction or efficiency of each wavelength deviates from the optimal conditions. Thus, the light emitted from the chromatic aberration-correcting element is quite different in angle from the incident light. The light beams are neither sufficiently condensed by the objective lens nor compatibly used. Thus, the chromatic aberration-correcting element according to an embodiment of the present invention has such a structure that the diffraction direction or efficiency of DVD and CD wavelengths is similar to the optimal conditions.

To overcome the problems of prior arts, the chromatic aberration-correcting element has a diffractive structure which diffracts light according to the following formula:
p sin θ=nλ Equation 3

where θ is a diffraction angle, p is a pitch of the diffractive structure (um), n is a diffraction order, and λ is a wavelength incident on the diffractive structure.

When a BD wavelength diffracts at an angle of θ₀ with a diffraction order of 1 and DVD and CD wavelengths diffract at angles of θ₁ and θ₂, respectively, with a diffraction order of 2, the diffraction angle can be calculated as follows in accordance with the above equation, on the basis that a BD wavelength λ₀ is 405 nm, a DVD wavelength λ₁ is 655 nm, and a CD wavelength λ₂ is 785 nm.
sin θ₀=2λ₀/p=0.81/p
sin θ₁=λ₁/p=0.655/p
sin θ₂=λ₂/p=0.785/p

Within a small angle range, thus, the diffraction angle with regard to the BD wavelength is calculated to be 0.655/0.81 for the DVD wavelength and 0.785/0.81 for the CD wavelength. There are no large differences in diffraction angle.

When all BD, DVD and CD wavelengths are first order, the following relationships are obtained:
sin θ₀=λ₀/p=0.405/p
sin θ₁=λ₁/p=0.655/p
sin θ₂=λ₂/p=0.785/p

Under the above conditions, the diffraction angle with regard to the BD wavelength amounts to 0.655/0.405=1.62 for the DVD wavelength and to 0.785/0.405=1.94 for the CD wavelength. In this case, a diffraction efficiency of about 60% is obtained for each wavelength.

From the calculations, it is apparent that second-order diffracted light is used for BDs while first-order diffracted light is used for CDs and DVDs.

In the chromatic aberration-correcting element 10 of FIG. 1B, therefore, the diffractive structure 15 has a groove depth and a saw-toothed shape such that a maximal diffraction efficiency is obtained in second-order diffracted light beams for BDs and in first-order diffracted light beams for DVD/CDs, while correcting chromatic aberration in BD light beams.

Though DVD/CD light beams are incident on the chromatic aberration-correcting element according to an embodiment of the present invention, a change in diffraction angle due to wavelength difference is counterbalanced with a change in diffraction angle due to diffraction order difference, so that the light beams emitted from the element have almost the same angle as that of the incident light beams. Thus, the chromatic aberration-correcting element 10 can be positioned in the path of DVD/CD wavelengths without negative influence on the compatible adoption of DVDs/CDs, thereby integrating a BD optical system and a DVD/CD optical system. The chromatic aberration-correcting element 10 enjoys the advantage of making an optical pickup device simple in structure.

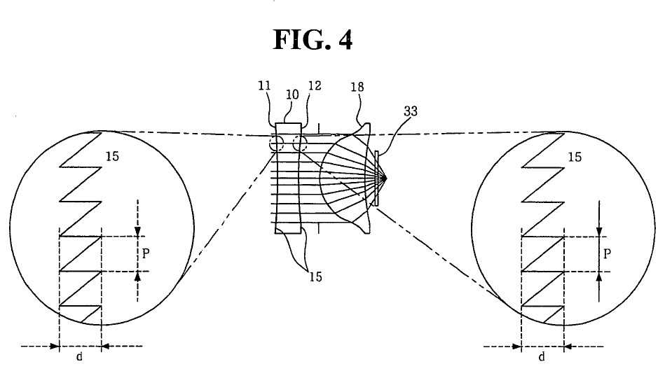

With reference to FIGS. 3 and 4, operational examples of the chromatic aberration-correcting element 10 are described. FIG. 3 shows paths of the light beams passing through the chromatic aberration-correcting element 10 which is seen in a partially enlarged view of FIG. 4. The chromatic aberration-correcting element 10 according to an embodiment of the present invention is made from a transparent plastic material, sold under the trade name of ZEONEX 330R, and has, as seen in FIG. 3, an aspheric concave plane on each side 11 and 12. A diffractive structure 15 is also provided on each aspheric concave plane. The diffractive structure is formed in a saw-toothed shape with a pitch p and a step depth d, as shown in FIG. 4 and has a saw-toothed design so as to increase the diffraction efficiency of the light beams of predetermined order number. The plastic material ZEONEX 330R has a refractive index of 1.525 (n₀) at a BD wavelength of 405 nm (λ₀), 1.507 (n₀₁) at a DVD wavelength of 655 nm (λ₁), and 1.503 (n₂) at a CD wavelength of 655 nm (λ₂). However, the material ZEONEX 330R is illustrative, but does not limit the present invention.

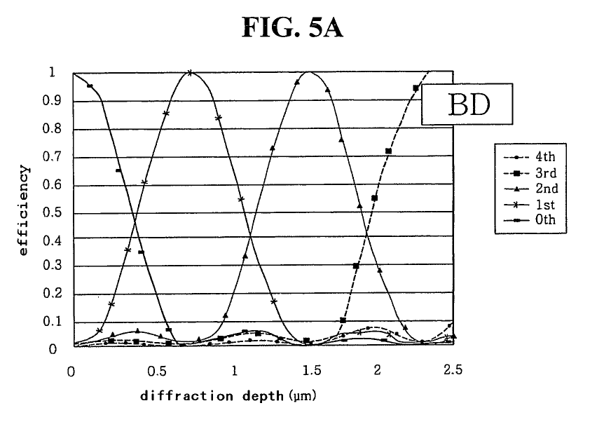

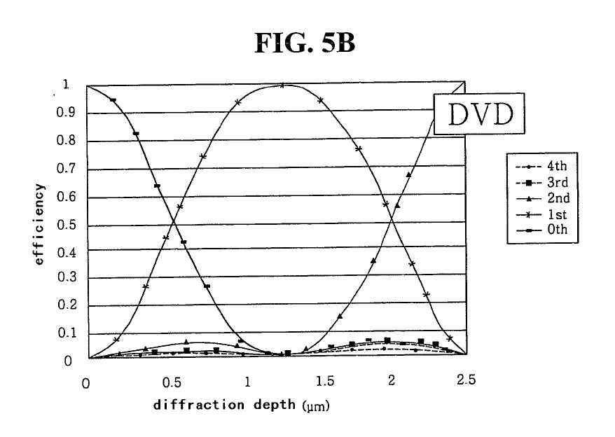

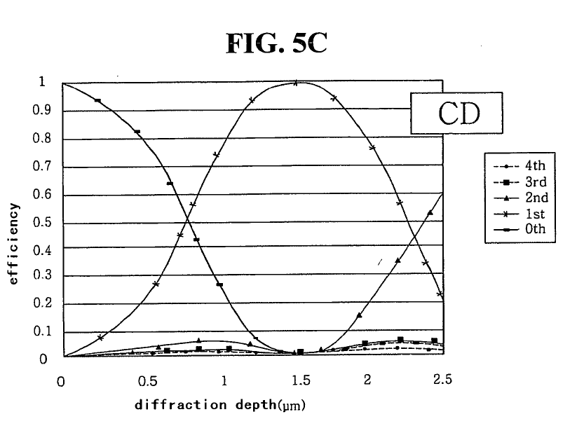

FIGS. 5A, 5B and 5C show the relationship of the diffraction efficiency to the step depth d with regard to each wavelength. Diffraction efficiencies are plotted versus step depths for a wavelength for the high-density medium BD in FIG. 5A, for a wavelength for the first low-density medium DVD in FIG. 5B, and for a wavelength for the second low-density medium CD in FIG. 5C. At a step depth of around 1.5 um, the diffraction efficiency amounts to 95% or higher for the second-order diffracted light of the BD wavelength λ₀, to 95% or higher for the first-order diffracted light of the DVD wavelength λ₁, and to 90% or higher for the second-order diffracted light of the DVD wavelength λ₂. From these results, maximal diffraction efficiencies can be obtained for the second-order diffracted light of BD wavelength and the first-order diffracted light of DVD/CD wavelengths when the step depth d of the diffractive structure is set to be 1.5 um.

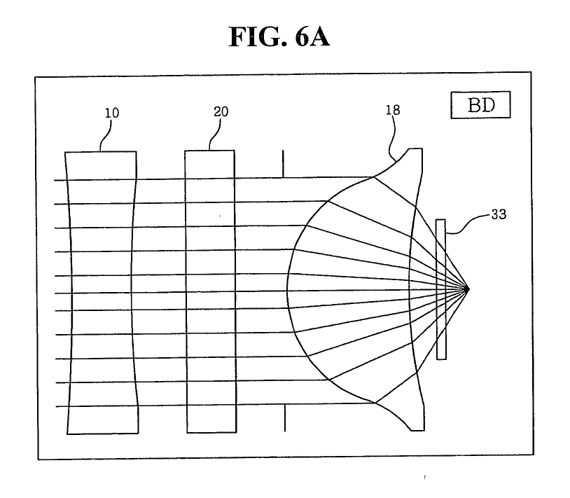

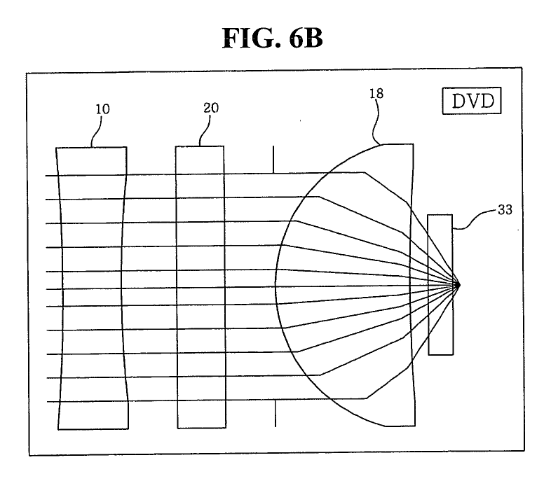

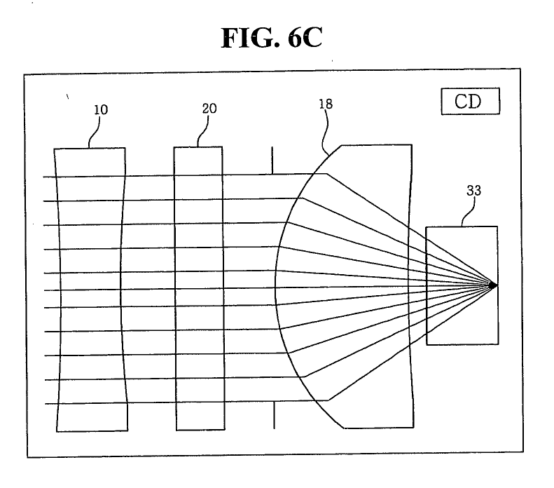

Referring to FIGS. 6A, 6B and 6C, the paths that light beams take are traced in an optical pickup device provided with the chromatic aberration-correcting element 10. FIG. 6A is for the second order diffraction light beams for BDs, FIG. 6B is for the first-order diffraction light beams for DVDs, and FIG. 6C is for the first-order diffraction light beams for CDs. As seen in the figures, each of the light beams transmitted through the chromatic aberration-correcting element 10 passes through a diffractive optical element for allowing the universal adoption of BD, DVD and CD light beams before being incident on an objective lens 18. Numeral 33 represents a cover glass.

Upon calculating waterfront aberrations generated by the paths that the above-stated light beams take, 0.005 λrms is obtained for BD light, 0.02 λrms for DVD light, and 0.01 λrms for CD light. Satisfying not only Marechal's condition for waterfront aberration (waterfront aberration<0.07 λrms), but also the condition for a recording system (waterfront aberration<0.033 λrms), these waterfront aberration values show that the chromatic aberration-correcting element of the present invention can be applied to all light beams for BDs, DVDs and CDs without degradation in data recording and reproducing properties. Therefore, the chromatic aberration-correcting element of the present invention can correct chromatic aberrations in BD light beams, as well as allowing a simple pickup device to universally adopt DVD/CD light beams.

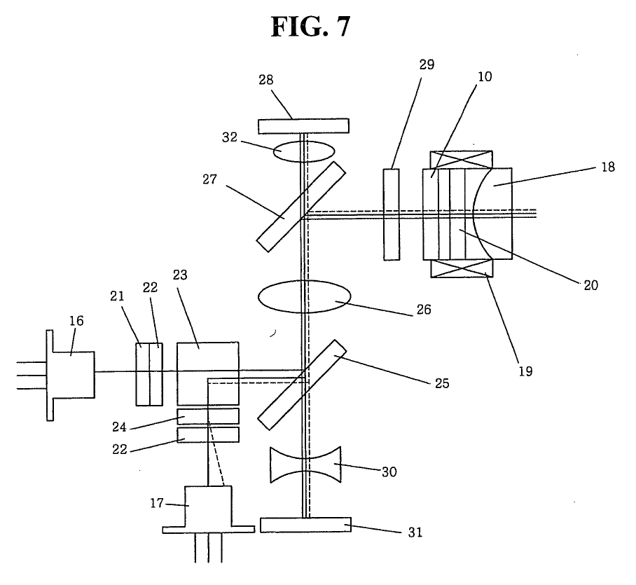

A detailed description will be given of the structure of the optical pickup device provided with the chromatic aberration-correcting element of the present invention, with reference to FIG. 7. First, elements used in general optical pickup devices are illustrated.

In the figure,

numeral 16 is a laser diode for blue discs (wavelength 405 nm), referred to as “BD LD”;

numeral 17 is a two-wavelength laser diode emitting a DVD wavelength (655 nm) beam and a CD wavelength (785 nm) beam, referred to as “TWIN LD”;

numeral 21 is a half wave plate for rotating the polarization state of plane polarized light, referred to as “HWP”;

numeral 22 is a grating forming a sub-spot on a disc to detect tracking error signals, referred to as “GT”;

numeral 24 is a holographic optical element for joining optic axes of DVDs and CDs, referred to as “HOE”;

numeral 23 is a dichroic beam splitter for combining DVD and CD beams with BD beams, referred to as “Dichroic BS”;

numeral 25 is a polarized beam splitter for reflecting light into or transmitting light from discs, referred to as “PBS”;

numeral 26 is a collimate lens for forming parallel beams, referred to as “CL”;

numeral 27 is a leakage mirror with a reflectance of 90% and a transmittance of 10%, for use in detecting beam power with a front monitor photo detector;

numeral 28 is a front monitor photo detector for controlling the strength of the light incident on discs, referred to as “FPD”;

numeral 29 is an element in which a liquid crystal element, referred to as “LCE”, for correcting the spherical aberration due to disc thickness variation or due to double-layer discs is combined with a quarter wave plate, referred to as “QWP”, for turning plane-polarized light into circularly polarized light and vice versa;

numeral 30 is a sensor lens for detecting focus error signals, referred to as “SL”; and

numeral 31 is a photo detector with an integrated circuit for detecting read signals and focus/tracking error signals.

The optical pickup device provided with the chromatic aberration-correcting element of the present invention is operated as follows.

As a light source for recording or reproducing data, the BD LD 16 is utilized. The light beams emitted from the BD LD 16 pass through the HWP 21, the GT 22 and the dichroic BS 23 and then are reflected at the PBS 25 toward the CL 26 at which they are converted into parallel beams. The HWP 21 rotates the polarization state of incident beams such that almost all of the beams are reflected at the PBS 25, but may not be installed corresponding to the position of the BD LD 16. Also, the GT 22 is required to form sub-spots on a disc and conduct tracking motion according to a differential push-pull method. The dichroic BS 23 functions to transmit approximately 90% of wavelengths of around 408 nm, reflect approximately 90% of wavelengths of around 655 nm and 785 nm, and synthesize light beams suitable for recording on and reproducing from BDs and DVD/CDs.

A part (about 10%) of the parallel beams passing through the CL 26 are transmitted through the leakage mirror 27 and then condensed through a condensing lens 32 to the FPD 28. By monitoring the signals condensed to the FPD 28, the emission strength of the BD LD 16 is controlled, so as to stably record or reproduce data.

In the meantime, the beams reflected by the leakage mirror 27 pass through the element 29 in which the LCE and the QWP are combined together and then through the chromatic aberration-correcting element 10 of the present invention and focused through an objective lens 18 on a blue laser disc. The LCE serves to correct spherical aberrations due to the thickness variation in a disc cover layer or due to double layer discs. In the QWP, the change of linearly polarized light into yen polarized light occurs. The chromatic aberration-correcting element 10 correct the wavelength fluctuation due to the mode hop between reproduction and recording.

After being converted into linearly polarized beams perpendicular to the incident beams by the QWP, the light beams reflected from the disc pass through the PBS 25 and the SL 30 and then are condensed into the PDIC 31. The SL 30 is formed in a cylindrical form to detect focus error signals according to an astigmatic method. The PDIC 31 detects reproducing signals and error signals for controlling focus/tracking motion while an actuator is controlled according to control signals which are returned to an actuator driving circuit 19 in a feedback pattern so as to stably record or reproduce data.

For recording on or reproducing from DVDs, light beams with a wavelength of 655 nm emitted from the TWIN LD 17 data are utilized. The light beams emitted from the TWIN LD 17, after passing through the GT 22 and the HOE 24, are reflected at the dichroic BS 23 and then at the PBS 25 toward the CL 26 at which they are converted into parallel beams. Because the HOE 24 is designed so as not to operate in response to DVD wavelengths, it has no influence on the light transmitted therethrough. The GT 22 is required to form sub-spots on a disc to conduct a tracking motion according to a differential push-pull method.

A part (about 10%) of the parallel beams which pass through the CL 26 are transmitted through the leakage mirror 27 and then condensed through a condensing lens 32 to the FPD 28. By monitoring the signals from the FPD 28, the emission strength of the TWIN LD 17 is controlled, so as to stably record or reproduce data.

In the meantime, the beams reflected by the leakage mirror 27 pass through the element 29 in which the LCE and the QWP are combined with each other and then through the chromatic aberration-correcting element 10 of the present invention and focused through an objective lens 18 on a DVD. The operation of the LCE is not required because DVD light beams need not be corrected by the LCE. The QWP serves to change linearly polarized light into yen polarized light. After being incident on the chromatic aberration-correcting element 10, the parallel beams are changed into divergent beams capable of recording and reproducing data, by the diffractive structure.

Light beams reflected from the disc, after being converted into linearly polarized beams perpendicular to the incident beams by the QWP, pass through the PBS 25 and the SL 30 and then are condensed into the PDIC 31. The SL 30 has such a cylindrical form as to detect focus error signals according to an astigmatic method. The PDIC 31 detects reproducing signals and error signals for controlling focus/tracking motion while an actuator is controlled according to control signals which are returned to an actuator driving circuit 19 in a feedback pattern so as to stably record or reproduce data.

As in DVDs, recording on or reproducing from CDs uses the TWIN LD 17 as a light source, but only 785 nm beams among those emitted from TWIN LD 17 are applicable therefor. The CD beams from the TWIN LD 17 pass through the GT 22 and the HOE 24, followed by reflection at the dichroic BS 23 and then at the PBS 25 to direct the beams toward the CL 26. At the CL 26, the reflected beams are converted into parallel beams. Because the HOE 24 is so designed as to diffract CD wavelengths, it changes the angle of the light beams transmitted therethrough so that the parallel beams are directed at the same angle as in the DVD wavelengths. The GT 22 is required to form sub-spots on a disc to conduct a tracking motion according to a three-spot method.

A part (about 10%) of the parallel beams which pass through the CL 26 are transmitted through the leakage mirror 27 and then condensed through a condensing lens 32 to the FPD 28. By monitoring the signals from the FPD 28, the emission strength of the TWIN LD 17 is controlled, so as to stably record or reproduce data.

In the meantime, the beams reflected by the leakage mirror 27 pass through the optical element 29 in which the LCE and the QWP are combined with each other and then through the chromatic aberration-correcting element 10 of the present invention, and focused on a CD by the objective lens 18. The operation of the LCE is not required because CD light beams need not be corrected by the LCE. The linearly polarized light is changed into yen polarized light by the QWP. After being incident on the chromatic aberration-correcting element 10, the parallel beams are changed into divergent beams capable of recording and reproducing data, by the diffractive structure.

Light beams reflected from the disc, after being converted into linearly polarized beams perpendicular to the incident beams by the QWP, pass through the PBS 25 and the SL 30 and then are condensed into the PDIC 31. The SL 30 has such a cylindrical form as to detect focus error signals according to an astigmatic method. The PDIC 31 detects reproducing signals and error signals for controlling focus/tracking motion while an actuator is controlled according to control signals which are returned to an actuator driving circuit 19 in a feedback pattern so as to stably record or reproduce data.

A feature of the present invention, as described hereinbefore, is that the chromatic aberration-correcting element of the present invention enables a photo detector to be commonly used for BD, DVD and CD wavelengths, thereby simplifying the structure of the optical pickup device provided therewith. In addition, the chromatic aberration-correcting element enables a single objective lens to be applicable to BD, DVD and CD wavelengths. Simplification in the structure of the optical pickup device is also attributed to the fact that the chromatic aberration-correcting element allows a photodetector, which detects light beams reflected from the high-density recording medium and from the low-density recording medium, to be used in common.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A chromatic aberration-correcting optical system for use in an optical pickup device, comprising:
at least one concave plane for changing light beams for a high-density recording medium and for at least one low-density recording medium into divergent or convergent light beams; and
a diffractive structure, formed on at least one side, for changing divergent or convergent light beams into parallel light beams, whereby the chromatic aberration-correcting optical system can correct chromatic aberrations in light beams for the high-density medium and allows the light beams for the high-density recording medium and for the low-density recording medium to be universally used in the optical pickup device.

2. An optical pickup device, comprising:
a chromatic aberration-correcting optical system of claim 1; and
a common photodetector for detecting light beams reflected from the high-density recording medium and the low-density recording medium, said light beams reflected from the high-density recording medium taking the path of incident light beams due to the operation of the chromatic aberration-correcting optical system.

3. The chromatic aberration-correcting optical system as set forth in claim 1, wherein the diffractive structure is formed on at least one side of the chromatic aberration-correcting optical system in a concentric pattern which has a step depth and a saw-toothed form so as to confer a maximal diffraction efficiency to second-order diffraction light beams for the high-density recording medium and to first-order diffraction light beams for the low-density recording medium, whereby the chromatic aberration-correcting optical system enables light beams for the high-density recording medium and the low-density recording medium to use a common path without negative influence on the chromatic aberration of the high-density recording medium and the universal adoption of the high- and the low-density recording medium.

4. An optical pickup device, comprising:
a chromatic aberration-correcting optical system of claim 3; and
a common photodetector for detecting light beams reflected from the high-density recording medium and the low-density recording medium, said light beams reflected from the high-density recording medium taking the path of incident light beams due to the operation of the chromatic aberration-correcting optical system.

5. A chromatic aberration-correcting optical system for use in an optical pickup device, comprising a concave lens and a convex lens in combination, said convex lens having a diffractive structure on at lest one side, whereby the chromatic aberration-correcting optical system can correct chromatic aberrations in light beams for a high-density recording medium and allows the universal adoption of light beams for the high-density recording medium and at lest one low-density recording medium.

6. An optical pickup device, comprising:
a chromatic aberration-correcting optical system of claim 5; and
a common photodetector for detecting light beams reflected from the high-density recording medium and the low-density recording medium, said light beams reflected from the high-density recording medium taking the path of incident light beams due to the operation of the chromatic aberration-correcting optical system.

7. The chromatic aberration-correcting optical system as set forth in claim 5, wherein the diffractive structure is formed on at lest one side of the chromatic aberration-correcting optical system in a concentric pattern which has a step depth and a saw-toothed form so as to confer a maximal diffraction efficiency to second-order diffraction light beams for the high-density recording medium and to first-order diffraction light beams for the low-density recording medium, whereby the chromatic aberration-correcting optical system enables light beams for the high-density recording medium and the low-density recording medium to use a common path without negative influence on the chromatic aberration of the high-density recording medium and the universal adoption of the high- and the low-density recording medium.

8. An optical pickup device, comprising:
a chromatic aberration-correcting optical system of claim 7; and
a common photodetector for detecting light beams reflected from the high-density recording medium and the low-density recording medium, said light beams reflected from the high-density recording medium taking the path of incident light beams due to the operation of the chromatic aberration-correcting optical system.
